(19) United States
(12) Patent Application Publication
(10) Pub. No.: US 2003/0232595 A1
(43) Pub. Date: Dec. 18, 2003

(54) Wireless repeater apparatus, system, and method

(76) Inventors: Michael R. Baker, Saint Charles, MO (US); Kenneth Lynn Chilson JR., Irving, TX (US); Charles Lewis Richoz, Harlingen, TX (US)

Correspondence Address: Brian C. Kunzler, Suite 425, 10 West 100 South, Salt Lake City, UT, 84101, US

(21) Appl. No.: 10/414,723

(22) Filed: Apr. 16, 2003

Related U.S. Application Data
(60) Provisional application No. 60/373,351, filed on Apr. 17, 2002.

(51) Int. Cl. H04B 7/15

(52) U.S. Cl. 455/11.1; 455/13.3; 455/562.1; 455/575.7; 455/101

(57) ABSTRACT

A wireless repeater for repeating a wireless signal without necessarily transforming the wireless signal is provided. The wireless repeater includes a plurality of external antennas, each external antenna configured to operate within one or more wireless frequency bands. The wireless repeater includes a plurality of internal antennas, each internal antenna configured to operate within one or more wireless frequency bands associated with the external antennas. An amplifier unit is connected to the external antennas and internal antennas. The amplifier unit is configured to identify a frequency associated with an incoming wireless signal from within a plurality of wireless frequency bands. The amplifier unit also determines a signal strength for the incoming wireless signal and adjusts the signal strength of the incoming wireless signal to compensate for a loss in signal strength between the external antennas and the internal antennas. The amplifier unit interacts with the wireless signal in a manner whereby the incoming wireless signal is not substantially transformed.

### RELATED APPLICATIONS

This application is a continuation-in-part of and claims priority to U.S. Provisional Patent Application No. 60/373,351, filed on Apr. 17, 2002 and entitled “Universal Translator System,” which is incorporated herein by reference.

### BACKGROUND OF THE INVENTION

1. The Field of the Invention

The invention relates to providing wireless services. Specifically, the invention relates to devices, methods, and systems for repeating a wireless signal without transforming the wireless signal.

2. The Relevant Art

Wireless services have become pervasive. Mobile telephones, wireless email, wireless Internet connections, paging systems, and Global Positioning System (GPS) technologies are widely and frequently used. Many users have become so dependent on wireless communication that they use wireless devices as their principal means of communication.

Wireless communications, however, frequently break down inside of buildings. The walls, roofs, structure, wiring, and conduits of a building interfere with wireless signals entering or exiting the building. As a result, wireless communications are severely impeded or completely prevented.

FIG. 1 illustrates a conventional system 100 for addressing the problem. The system 100 includes one or more wireless base stations 102. The system 100 repeats external wireless signals from the base stations 102 to a wireless device 106 within a building 108. Similarly, the system 100 repeats internal wireless signals from a wireless device 106 to the base stations 102. The wireless device 106 may comprise a cell phone. Generally, the problem of building interference is most pronounced for users of wireless devices who are temporarily in a building such as at a retail outlet.

In addition, the system 100 includes a repeater 110. Generally, the repeater 110 is installed in the building 108 in a convenient location for maintenance or repair. The repeater 110 receives external wireless signals from a base station 102 and transmits a repeated wireless signal of the original wireless signal to a wireless device 106 within the building 108. Similarly, the repeater 110 receives a wireless signal from a wireless device 106 and repeats the wireless signal to the base stations 102. Generally, the repeater 110 includes an amplifier (not shown) that boosts the strength of the wireless signal. The repeater 110 also includes additional equipment that transforms or modifies the signal.

The system 100 includes an external transceiver 112 mounted outside the building 108 and an internal transceiver 114 mounted inside the building and positioned to provide the most efficient coverage for transmitting and receiving the wireless signals within the building 108. Generally, the repeater 110 and associated transceivers 112, 114 are configured for a specific frequency band such as the Advanced Mobile Phone System (AMPS) band. Consequently, to support other frequency bands, additional repeaters 110 and transceivers 112, 114 must be installed.

Certain conventional systems have been developed to support multiple frequency bands. Unfortunately, these systems do little to reduce the number of components and the expense necessary to support multiple frequency bands. For example, one system includes an internal antenna and internal transceiver as well as an external antenna and external transceiver, for each frequency band supported. This is substantially the same configuration as installing multiple separate repeaters 110 and transceivers 112, 114; however, the number of amplifiers may be reduced.

In one system, each internal antenna and internal transceiver pair is connected to a combiner that combines the signals from multiple bands and passes the signals through a single multi-band amplifier. Next, the signals pass through a separator that divides the signals back into the multiple frequency bands and sends the signals to corresponding external antenna and external transceiver pairs. This system adds complexity because the signals are being transformed (i.e. broken down into their component parts and reassembled). The signals are combined and separated. As a result, each of these steps may introduce errors in the signals. Furthermore, the system provides minimal cost benefits because a set of internal and external antenna and transceiver pairs must be installed for each frequency band supported.

In addition, the use of transceivers 112, 114 suggests that the signals are transmitted in such a manner that requires that the system be licensed by a government agency such as the Federal Communications Commission (FCC). Licensing and frequency coordination increases the cost of the system.

Furthermore, conventional systems do not include the capability of repeating a GPS frequency signal. Even if a conventional system were able to support GPS, an additional set of antennas, transceivers, and amplifiers may again be required. The expense for this additional hardware could prevent wide-spread use of wireless devices in buildings. In addition, conventional systems are expensive to modify in order to accommodate new frequency bands or new capabilities that may be used in the future.

Accordingly, what is needed is an apparatus, system, and method for a wireless repeater that solves the problems described above. The wireless repeater should be simple, inexpensive, and support a plurality of wireless frequency bands. In addition, the wireless repeater should amplify the wireless signals from outside and within a building in such a manner that the need for regulatory licensing is avoided. Furthermore, the wireless repeater should not transform the wireless signal in order to simplify and minimize the number of hardware components. In addition, the wireless repeater would be beneficial if it could accommodate new wireless signal bands by providing for a modular architecture to support additional frequency bands.

### SUMMARY OF THE INVENTION

The various elements of the present invention have been developed in response to the present state of the art, and in particular, in response to the problems and needs in the art that have not yet been fully solved by currently available repeaters for wireless devices. Accordingly, the present invention provides an improved apparatus, system, and method for repeating a wireless signal without necessarily substantially transforming the wireless signal.

In one embodiment, the wireless repeater includes a plurality of external antennas, each external antenna configured to operate within one or more wireless frequency bands. Preferably, certain external antennas are configured to operate within two or more wireless frequency bands. Each external antenna communicates with one or more base stations.

The external antennas are positioned outside of a building or other obstruction such that the external antennas receive wireless signals over a broad range of frequency bands preferably between about 800 MHz and about 5800 MHz. Consequently, the external antennas are preferably installed in an area of sufficient wireless signal strength such as the roof of a building. Sufficient signal strength means a signal strength suitable for communicating with a wireless device as though the device were collocated with the external antenna.

The wireless repeater also includes a plurality of internal antennas, each internal antenna configured to operate within the one or more wireless frequency bands associated with the external antennas. Preferably, a single internal antenna is configured to operate in more than one frequency band. For each frequency band supported by an external antenna, the repeater includes at least one internal antenna capable of operating in the frequency band.

The internal antennas and external antennas are in communication with an amplifier unit configured to identify a frequency associated with an incoming wireless signal from a plurality of wireless frequency bands. Preferably, the amplifier unit is configured to receive wireless signals over a broad range such as between about 800 MHz and about 5800 MHz.

In addition, the amplifier unit is configured to determine a signal strength for the incoming wireless signal and adjust the gain of the incoming wireless signal to compensate for a loss in the signal strength between the external antennas and the internal antennas without substantially transforming the signal. Preferably, the gain of the incoming wireless signal is restored to about the same level as the signal strength when the incoming wireless signal was detected by an internal or external antenna.

In certain embodiments, the amplifier unit does not transform the incoming wireless signal. As used herein, transforming a wireless signal means to separate the wireless signal into one or more distinct signal components and then re-combine the signal components before the signal exits a system. Instead, the amplifier unit includes various hardware modules for filtering and amplifying the incoming wireless signal based on the identified frequency.

Preferably, the amplifier unit includes filters and corresponding amplifiers that are activated based on the determined frequency for the incoming wireless signal. The filter delivers the wireless signal to an amplifier, also referred to as a gain component. The amplifier is configured to amplify wireless frequencies of a specific frequency band associated with the frequency band passed by the filter. Preferably, as mentioned above, the amplifier provides sufficient gain such that the wireless frequency exits an internal antenna or external antenna with substantially the same signal strength as the wireless signal strength when the signal was originally received by the system.

In certain embodiments, the amplifier unit communicates with the external antennas and internal antennas by way of conventional communication links such as coaxial cable. This allows the signal to be passed through the system without frequency translation or other modifications.

The present invention also includes a method for repeating a wireless signal without transforming the wireless signal. Initially, a frequency associated with an incoming wireless signal from a plurality of predetermined wireless frequency bands is identified. Next, a signal strength for the incoming wireless signal is determined. The gain of the incoming wireless signal is adjusted to compensate for a loss in the signal strength between a plurality of external antennas in communication with a plurality of internal antennas carrying the incoming wireless signal without substantially transforming the signal. Finally, the gain-adjusted incoming wireless signal is passed between the external antennas and internal antennas.

In another embodiment, the present invention provides a system for repeating a wireless signal without transforming the wireless signal. The system includes a controller configured to identify a frequency for an incoming wireless signal from a plurality of wireless frequency bands receivable by the controller and to determine a signal strength for the incoming wireless signal. The controller activates a bandpass filter configured to pass the identified frequency comprising the incoming wireless signal. The filtered incoming wireless signal is sent to a gain component corresponding to the bandpass filter. The gain component is configured to adjust the gain of the incoming wireless signal to substantially restore the incoming signal to the signal strength determined by the controller. The boosted incoming signal is then passed between an external antenna and an internal antenna.

In one embodiment, the system includes a plurality of bandpass filters and corresponding gain components configured for a specific wireless frequency band, block, and/or channel. The controller directs the incoming wireless signal to the appropriate bandpass filter and gain component based on the determined frequency for the incoming wireless signal.

Of course, the incoming wireless signal may originate from a wireless device through the internal antennas (uplink signal) or from a base station through the external antennas (downlink signal). In a preferred embodiment, the system includes an uplink diplexer module that directs uplink signals through a set of uplink bandpass filters and gain components. The system also includes a substantially similar downlink diplexer module that directs downlink signals through a substantially similar set of downlink bandpass filters and gain components. Alternatively, a controller for the system may route incoming signals (uplink and downlink) through a set of bandpass filters and gain components based on whether the signal is an uplink signal or a downlink signal.

In one embodiment, the present invention comprises a modular external antenna set and a modular internal antenna set. The modular external antenna set and modular internal antenna set are configured to provide connections to one or more modular external and internal antennas respectively. Preferably, the modular external antenna set and a modular internal antenna set include at least one available connection. The connections may be used to connect at least one an additional modular external antenna and at least one an additional modular internal antenna.

In addition, the amplifier unit may be configured to receive a plurality of modular amplifiers. Consequently, if a new wireless frequency band becomes available, a modular external antenna and modular internal antenna may be connected respectively to the modular external antenna set and modular internal antenna set. A modular amplifier may be added to the amplifier unit such that the modular amplifier, modular external antenna, and modular internal antenna cooperate to provide a modular repeater for the new wireless frequency band. Of course the modular amplifier, modular external antenna, and modular internal antenna may support two or more frequency bands. Consequently, support for a new wireless frequency band may or may not require the addition of a modular amplifier, modular external antenna, or modular internal antenna.

The present invention is simple, inexpensive, and supports a plurality of wireless frequency bands. In addition, the present invention amplifies the wireless signals from outside and within a building without adding sufficient power to, or transforming, the signal such that regulatory licensing is required. Furthermore, the present invention does not necessarily transform the wireless signal in order to simplify and minimize the number of hardware components. In addition, embodiments of the present invention accommodate new wireless signal bands through a modular architecture. These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the advantages of the invention are obtained will be readily understood, a more particular description of the invention briefly described above will be rendered by reference to specific embodiments thereof, which are illustrated in the appended drawings. These drawings depict only typical embodiments of the invention and are not therefore to be considered to be limiting of its scope, the invention will be described and explained with additional specificity and detail through the use of the accompanying drawings in which:

FIG. 1 is a block diagram of a conventional wireless repeater;

FIG. 2 is a block diagram of one embodiment of the present invention;

FIG. 3 is a block diagram of one embodiment of the present invention;

FIG. 4 is a block diagram of one embodiment of a system for repeating a wireless signal without transforming the wireless signal according to the present invention;

FIG. 5 is a flow chart of a method for repeating a wireless signal without transforming the wireless signal according to one embodiment of the present invention; and

FIG. 6 is a block diagram of one embodiment of a modular wireless repeater for repeating a wireless signal without transforming the wireless signal.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

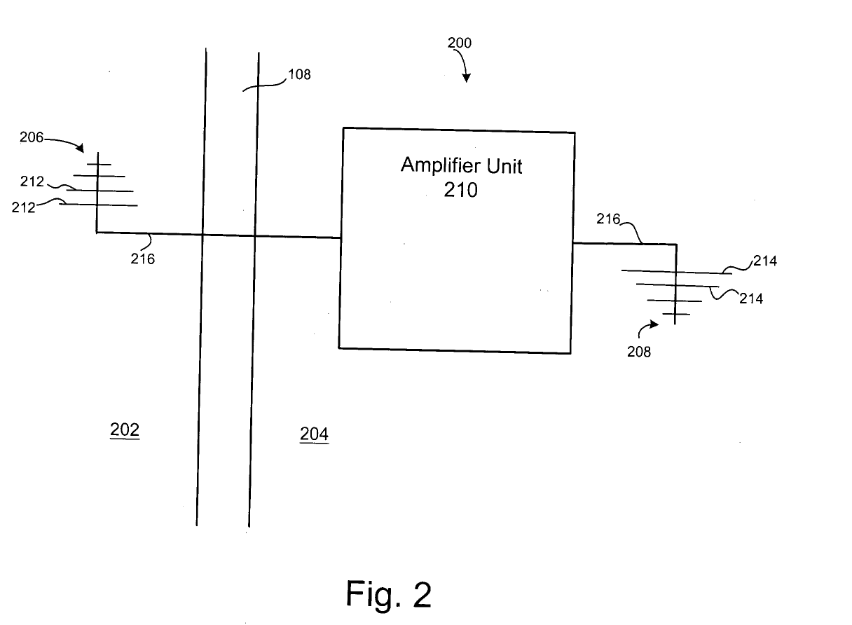

FIG. 2 illustrates one embodiment of a wireless repeater 200 for repeating a wireless signal without transforming the wireless signal. As mentioned above, buildings 108 and other structures interfere with wireless signals. Specifically, the building 108 creates a faraday shield effect that effectively prevents wireless signals from entering or exiting a building 108. Certain buildings 108 create more effective faraday shields than others. In particular, a building 108 made from material such as metal blocks more wireless signals than a building 108 may of material such as wood and brick. One example of buildings 108 that significantly block wireless signals are large warehouse retail outlets that are made principally from metal.

The faraday shield created by a building 108 may be very frustrating to users of wireless devices 106 moving from outside 202 to inside 204. On the outside 202, the device 106 may receive wireless signals readily. Once a user crosses the threshold of the building 108, however, the device 106 typically receives few or no wireless signals. Furthermore, users inside 204 the building 108 are often unable to send or receive wireless signals.

In one embodiment of the present invention, a wireless repeater 200 for repeating a wireless signal without transforming the wireless signal includes a plurality of external antennas 206 and a plurality of internal antennas 208 connected by an amplifier unit 210. The external antennas 206 are outside 202 the building 108. Preferably, the external antennas 206 are positioned such that a maximum number and type of wireless signals are detectable. For example, the external antennas 206 may be installed on the roof or high on the side of a building 108.

Each external antenna 212 is configured to operate within one or more wireless frequency bands. Certain external antennas 212 operate with a single wireless frequency band. Other external antennas 212 (known as multi-band antennas) operate with two or more wireless frequency bands.

Similarly, the wireless repeater 200 includes internal antennas 208. The internal antennas 208 are positioned inside 204 the building 108. Preferably, the antennas 208 are located high above a substantially open area within the building 108 to provide maximum coverage.

For each external antenna 212 there is preferably a corresponding internal antenna 214. The corresponding internal antenna 214 is configured to operate within one or more of the same wireless frequency bands as the external antenna 212. Preferably, the internal antenna 214 includes different physical characteristics compared to the associated external antenna 212 due to the respective different environments. For example, an internal antenna 214 may be smaller than the associated external antenna 212, because the range required for the internal antenna 214 is smaller. The external antenna 212 may be weather proof. Alternatively, the same physical device may function as an internal antenna 214 or an external antenna 212, depending on where the device is installed, either inside 204 or outside 202.

Preferably, the external antennas 206 and internal antennas 208 are connected to the amplifier unit 210 by a conventional electrical communication connection 216, such as coaxial cable. A single electrical communication connection 216 connects each internal antenna 214 and each external antenna 212 to the amplifier unit 210. Alternatively, one communication connection 216 may connect two or more internal or external antennas 214, 212 to the amplifier unit 210.

The external antennas 206 and the internal antennas 208 provide wireless signals to the amplifier unit 210 continuously. The amplifier unit 210 accepts the wireless signals from the external antennas 206 and passes the wireless signals to the internal antennas 208, and vice versa. The amplifier unit 210 in the depicted embodiment does not transform the wireless signals between the external antennas 206 and internal antennas 208.

The amplifier unit 210 preferably performs the same functions in relation to the wireless signal regardless of whether the wireless signal is delivered by the external antennas 206 or the internal antennas 208. Consequently, for simplicity and clarity, the wireless signal passing through the amplifier unit 210 shall be referred to hereinafter as an “incoming wireless signal” or “incoming signal.” “Incoming wireless signal” or “incoming signal” means any wireless signal that enters the amplifier unit 210 from the external antennas 206 or the internal antennas 208 and passes through to internal antennas 208 or external antennas 206, as appropriate.

The amplifier unit 210 is configured to identify a frequency associated with an incoming wireless signal. The frequency is preferably identified by sampling. The frequency is identified from within a broad range of frequencies that the wireless repeater 200 is configured to repeat. In one embodiment, the wireless repeater 200 is configured to repeat incoming wireless signals having a frequency in various frequency bands between about 800 MHz and about 5800 MHz. The amplifier unit 210 may also determine a frequency band that includes the identified frequency for the incoming wireless signal.

In addition, the amplifier unit 210 is configured to determine a signal strength for the incoming signal. In one embodiment, the amplifier unit 210 measures the power level of the incoming signal as the incoming signal enters the amplifier unit 210. Next, the amplifier unit 210 adjusts the strength of the incoming signal to substantially compensate for a loss in signal strength between the internal antenna 214 and the external antenna 212. Preferably, the amplifier unit 210 determines, based on well known formulas, how much to adjust the strength of the incoming signal. The loss in signal strength between the internal antenna 214 and the external antenna 212 comprises a calculated loss a wireless signal would experience traveling through the internal antenna 214, the external antenna 212, and the internal components of the amplifier unit 210. In one embodiment, the loss in signal strength between the internal antenna 206 and the external antenna 208 is a calculated value.

Preferably, the amplifier unit 210 adjusts the strength of the incoming signal up to, but not to exceed, the signal strength of the incoming signal detected by the internal antenna 214 or the external antenna 212. In this manner, the amplifier unit 210 ensures that the wireless signal exiting the wireless repeater 200 does not require regulatory licenses and frequency coordination. Of course, in certain embodiments, the signal could be amplified to a level that exceeds or is less than the detected incoming signal.

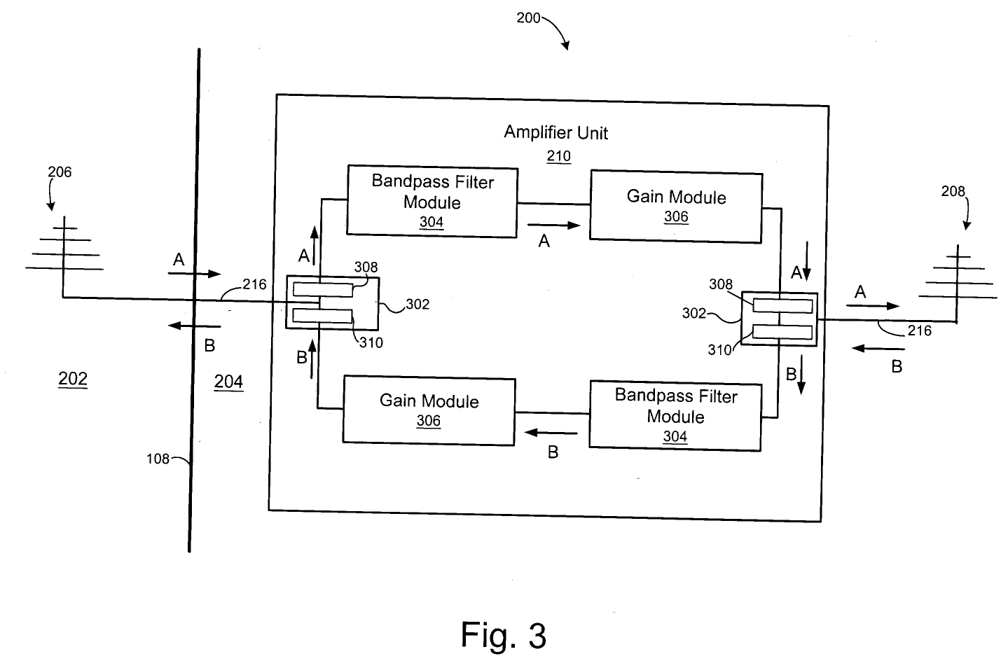

Referring now to FIG. 3, internal components for one embodiment of an amplifier unit 210 are illustrated. The amplifier unit 210 may include a pair of diplexer modules 302, a pair of bandpass filter modules 304, and a pair of gain modules 306. Preferably, an incoming signal passes through one bandpass filter module 304, and one gain module 306 before exiting the amplifier unit 210.

By way of illustration and example, a path traveled by a wireless signal from outside 202 through the wireless repeater 200 to the inside 204 (designated by Arrow A) will now be described. Those of skill in the art will readily recognize the similarity of the path for a wireless signal traveling from inside 204 to the outside 202 (designated by Arrow B). In the depicted embodiment, path B traverses the same components as path A, but in reverse order. Alternatively, the wireless signal may travel in opposite directions through a single bandpass filter module 304 and a single gain module 306.

In path A, one of the external antennas 206 first detects a wireless signal from outside 202. The wireless signal travels by way of a communication connection 216 through the building 108 to the diplexer module 302. The diplexer module 302 is electrically connected to the communication connection 216. Of course, a plurality of wireless signals may travel simultaneously along the communication connection 216 to the diplexer module 302. In certain embodiments, wireless signals having frequencies between about 800 MHz to about 5800 MHz are received by the diplexer module 302.

The diplexer module 302 serves as a one-way gate that allows only wireless signals originating from the external antennas 206 into the amplifier unit 210. Similarly, the diplexer module 302 also allows wireless signals from within the amplifier unit 210 to exit out to the external antennas. Consequently, the diplexer module 302 prevents incoming signals and outgoing signals from interfering with each other.

Preferably, the diplexer module 302 includes one or more uplink filters 308 and one or more downlink filters 310 that are configured to filter incoming wireless signals based on whether the wireless signals are wireless uplink frequencies or wireless downlink frequencies. As used herein, uplink frequencies refer to frequencies used by a wireless device 106 to send information to a base station 102, and downlink frequencies refer to frequencies used to send information from a base station 102 to a wireless device 106. As a representative example, conventional cellular wireless uplink frequencies are between about 824 MHz to about 849 MHz and conventional cellular wireless downlink frequencies are between about 869 MHz to about 894 MHz.

Of course those of skill in the art will readily recognize that the diplexer module 302 may comprise a single component such as a circuit board having one or more electrical circuits or may be implemented using one or more well known components. Continuing along path A, the diplexer module 302 routes the one or more wireless downlink signals to a bandpass filter module 304. For clarity, a single wireless signal is described traversing path A. Those of skill in the art will recognize, however, that the present invention readily allows for a plurality of wireless signals to pass through simultaneously.

The bandpass filter module 304 is configured to pass a specific wireless signal based on a predetermined frequency for the wireless signal. The bandpass filter module 304 discards all wireless signals received from the diplexer module 302 except for those that have one or more predetermined frequency bands. Preferably, the bandpass filter module 304 comprises inexpensive conventional filters corresponding to the one or more wireless frequency bands supported by the external antennas 206 as are commonly known in the art.

The bandpass filter module 304 provides the wireless signal along path A to the gain module 306. The gain module 306 adjusts the signal strength for the wireless signal so that the signal level received by a mobile unit inside the structure is at substantially the same level as the signal when received by one of the external antennas 206. Typically, there is a loss of signal strength as the wireless signal travels to the gain module 306. Consequently, the gain module 306 boosts the signal level of the wireless signal. Furthermore, the signal strength may also be boosted to compensate for any loss as the signal passes through the remainder of the amplifier unit 210 and out one of the internal antennas 208. Preferably, the signal level is not boosted above the signal level of the wireless signal detected by one of the external antennas 206.

The gain module 306 sends the wireless signal to a second diplexer module 302. The second diplexer module 302 is configured to direct wireless signals from within the amplifier unit 210 to a communication connection 216 connected to the internal antennas 208. At this point along path A, the incoming wireless signals comprise amplified downlink frequencies that are simultaneously sent along communication connection 216. Distinct filtering and amplification of the frequencies of the incoming wireless signals minimizes interference. Similarly, the second diplexer module 302 directs wireless signals from the internal antennas 208 along path B to a second bandpass filter module 304.

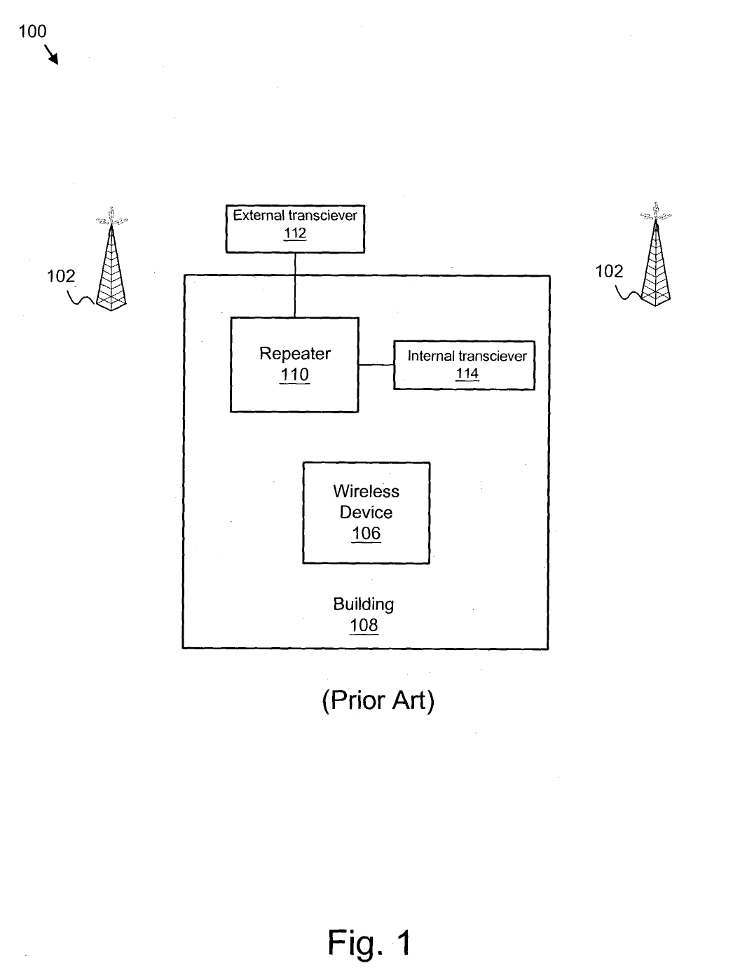

As a wireless signal passes from outside 202 to inside 204 the building 108 (path A), the wireless repeater 200 provides a conduit for the wireless signal, perferably without transforming the wireless signal. Similarly, wireless signals from inside 204 to outside 202 (path B) are passed without transformation. The wireless repeater 200 provides an effective “electronic” pathway though the building 108 allowing wireless signals to be sent and received by wireless devices 106 (See FIG. 1) within the faraday shield effect of the building. The signal strength is adjusted such that a base station 102 and wireless device 106 communicate as though the wireless device 106 were outside 202.

As mentioned above, the wireless repeater 200 effectively passes bands having frequencies between about 800 MHz and 5800 MHz. This means that wireless devices 106 such as mobile telephones operating at wireless frequencies within this range may use the wireless repeater 200. The wireless repeater 200 does not manipulate or transform the wireless signal. Consequently, the wireless repeater 200 does not require any complex logic that would be required to separate and re-combine a wireless signal without interrupting wireless communications.

In addition, the wireless repeater 200 is configured to repeat Global Positioning Satellite (GPS) frequencies. A GPS signal is a one-way signal originating from one or more satellites used to determine location. Preferably, the external antennas 206 include an external antenna 212 configured to receive the GPS frequencies. The wireless repeater 200 passes the GPS signal through the building 108. GPS capable devices 106 detect the GPS signal provided by a corresponding internal antenna 214.

Currently, GPS enabled devices 106 do not readily function inside 204 a building 108, exhibiting the faraday shield effect. Nevertheless, many cell phones include GPS functionality for use in an emergency. The GPS features allow authorities to be directed to a user once a emergency call is placed. The GPS features, unfortunately, may be completely ineffective if a user is within a shielded building 108 such as a retail outlet.

The present invention, in certain embodiments, allows a GPS signal to be used by the GPS capable device 106 to determine the device's location. The wireless repeater 200 allows the GPS features to function and notify authorities at least that the caller is near coordinates for the external antenna 212 receiving the GPS signal. Typically, this is sufficiently accurate to provide the needed assistance in an emergency.

Those of skill in the art will readily recognize numerous advantages that the ability to provide GPS signals to GPS enabled devices inside 204 a building 108 provides. In certain embodiments, the GPS signal may be used to more accurately identify where the GPS enabled device 106 is located within the building 108 because the dimensions of the building are known.

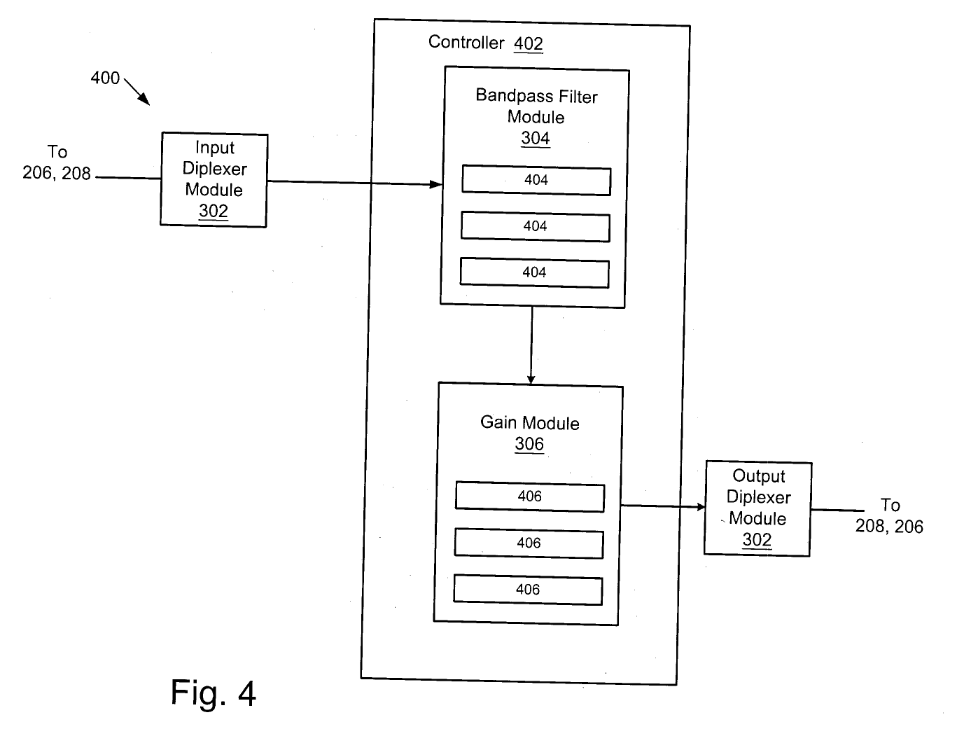

FIG. 4 illustrates one embodiment of a system 400 for repeating a wireless signal without transforming the wireless signal. As mentioned above, regardless of whether the incoming wireless signal originates from the external antennas 206 or the internal antennas 208, in a preferred embodiment, the incoming signal passes through the same basic components within the amplifier unit 210 (See FIG. 2).

Preferably, the system 400 includes separate hardware for performing the functions of filtering the incoming signal and adjusting the gain of the incoming signal. The separate hardware is specific to a frequency associated with an incoming wireless signal. Alternatively, one or more of the components described herein may be integrated into a multifunction component.

The system includes an input diplexer module 302. As discussed above, the diplexer module 302 keeps incoming and outgoing signals within the amplifier unit 210 separate. Input diplexer module 302 refers specifically to the diplexer module 302 receiving an incoming wireless signal from an external antenna 212 or an internal antenna 214. Those of skill in the art will recognize that one diplexer module 302 may be configured to serve as both an input diplexer module 302 and an output diplexer module 302. Preferably, the input diplexer module 302 is separate from the output diplexer module 302. In this manner, conventional, inexpensive, readily available electrical components may be used and the electrical architecture for the system is simplified.

In one embodiment, the input diplexer module 302 communicates with a controller 402. A controller 402 is a logic device capable of executing a set of instructions in response to certain input and output parameters. The controller 402 may comprise a microcontroller, microprocessor, processor, or other logic device. In addition, the controller 402 includes the necessary inputs, outputs, and memory to perform its function. Those of skill in the art will recognize that instructions for the controller 402 may be stored within or external to the controller 402.

Preferably, the controller 402 is programmed either through software or a hardware configuration to direct the incoming wireless signal from the input diplexer 302 through the bandpass filter module 304 and the gain module 306. The controller 402 communicates with the input diplexer 302, output diplexer 302, filter module 304, and gain module 306.

The controller 402 identifies a frequency for an incoming wireless signal. The frequency is identified from within a plurality of wireless frequency bands that the controller 402 is configured to receive. In one embodiment, the controller 402 samples from a range of wireless frequencies received from the input diplexer module 302 to identify the frequency associated with the incoming wireless signal.

In addition, the controller 402 determines a signal strength for the incoming wireless signal. The signal strength may be measured by sampling circuitry (not shown). Preferably, the sampling circuitry is within the input diplexer module 302. The determined signal strength may be increased to compensate for known signal loss between the internal/external antennas 206, 208.

Preferably, the system 400 includes a separate bandpass filter 404 and a separate gain component 406 for the frequency of an incoming wireless signal or for a block of frequencies that the system 400 is configured to repeat. Alternatively, a multi-band band pass filter 404 and multi-band gain component 406 may be used.

The controller 402 directs wireless signals into the bandpass filter 404 configured to pass the identified frequency associated with the incoming wireless signal. The controller 402 then directs the filtered incoming wireless signal into a gain component 406 configured to adjust the signal strength of the incoming signal to substantially restore the incoming signal strength to the signal strength determined by the controller 402.

The gain component 406 amplifies the incoming wireless signal. The amplified incoming wireless signal passes through an output diplexer module 302 to either a set of external antennas 206 or internal antennas 208. In this manner, the wireless signal is effectively repeated without transforming the wireless signal.

Preferably, the system 400 includes a plurality of bandpass filters 404 within a bandpass filter module 304 and a plurality of gain components 406 within a gain module 306. For each bandpass filter 404, there may be a corresponding gain component 406. Each bandpass filter 404 may be configured to pass a specific wireless frequency. Alternatively, a single gain component 406 may support multiple frequencies.

In one embodiment, the bandpass filters 404 are configured to filter out the incoming wireless signal at successively smaller ranges until the incoming wireless signal is filtered at an appropriate granularity. The appropriate filtering granularity may depend on the frequency band.

For example, certain cell phones operate within a specific wireless frequency range from about 824 MHz to about 894 MHz. Within the frequency range, the frequencies may be divided into blocks of channels that are allocated between different wireless service providers. Certain channels may be adjacent within each frequency block or between frequency blocks.

Consequently, in certain embodiments, one or more of the bandpass filters 404 may be configured to filter an incoming wireless signal for one of a plurality of allocated frequency blocks within a frequency band associated with the identified frequency of the incoming wireless signal. This means that the bandpass filter 404 may be configured to filter frequency bands having frequency blocks that are more narrow than in other frequency bands.

Furthermore, if two incoming wireless signals are simultaneously passed through the system 400, certain frequencies may be adjacent channels within a single frequency band or frequency block. For example, two cell phone carriers may operate adjacent allocated channels within adjacent frequency blocks. If the two incoming wireless signals are amplified within the single frequency band, one incoming signal may interfere with the other.

Consequently, certain bandpass filters 404 may be configured to filter a first incoming wireless signal from an allocated channel adjacent to an allocated channel for a second incoming wireless signal. Of course, the bandpass filter 404 operates based on the frequencies associated with the first incoming wireless signal and second incoming wireless signal.

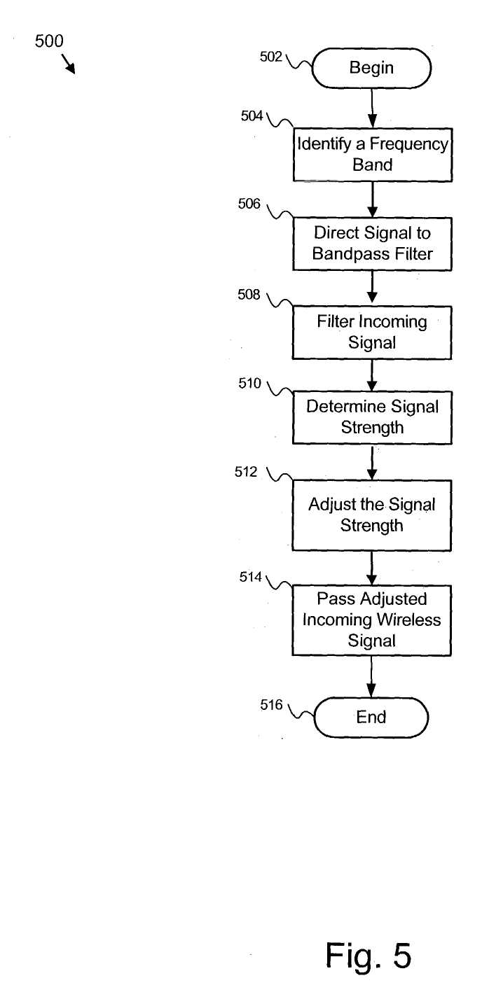

Referring to FIG. 5, a method 500 for repeating a wireless signal without transforming the wireless signal is illustrated. The method 500 begins 502 when a wireless signal is received by an external antenna 212 or an internal antenna 214. Subsequently, a frequency associated with an incoming wireless signal is identified 504. Preferably, the frequency is identified within a plurality of predetermined wireless frequency bands.

Next, the incoming wireless signal is directed 506 to a specific bandpass filter 404 (See FIG. 4) corresponding to the identified frequency. In certain embodiments, the incoming wireless signal is directed by filtering based on whether the incoming wireless signal is an uplink frequency or a downlink frequency. The incoming wireless frequency is then filtered 508 to isolate the incoming wireless signal from a plurality of either uplink or downlink frequencies. In certain embodiments, depending on the identified frequency associated with the incoming wireless signal, the incoming wireless signal may be filtered according to a plurality of wireless frequency blocks and/or allocated channels. For certain incoming wireless signals, the allocated channels may be adjacent.

A signal strength for the incoming wireless frequency is determined 510. The incoming wireless frequency is directed to a specific gain component 406 that adjusts 512 the signal strength of the incoming wireless signal to compensate for a loss in signal strength between an external antenna 212 and an internal antenna 214. Finally, the incoming wireless signal having an adjusted signal strength is passed 514 between an external antenna 212 or an internal antenna 214. The method 500 then ends 516.

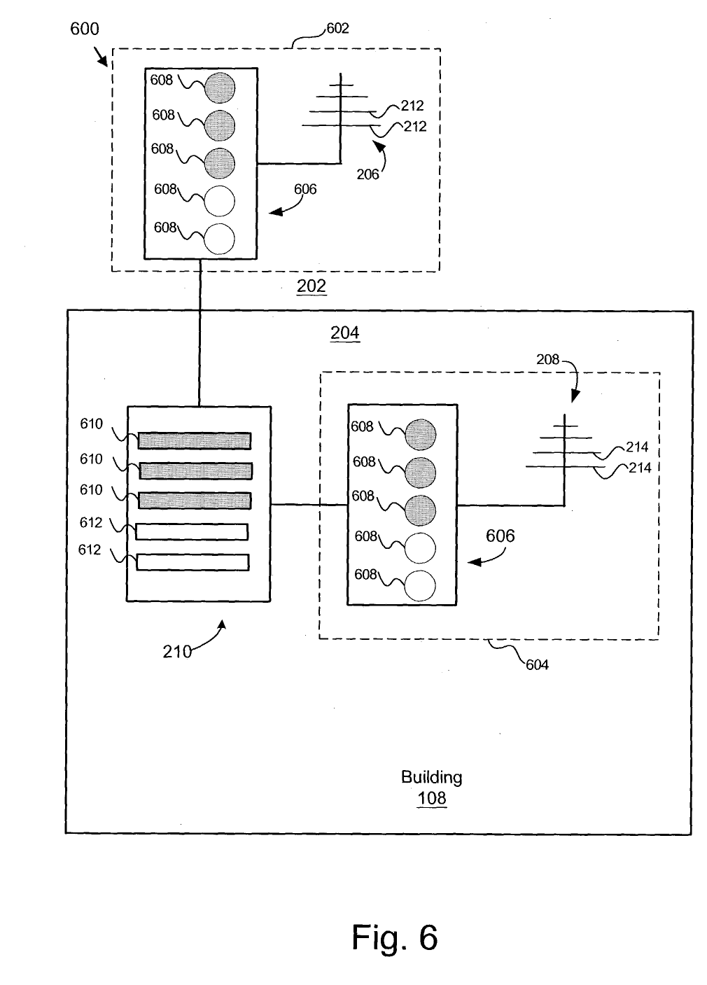

FIG. 6 is a block diagram of an alternative embodiment of the wireless repeater 200 of FIG. 2. Shown is a modular wireless repeater 600 for repeating a wireless signal without transforming the wireless signal. The modular wireless repeater 600 includes external antennas 206, internal antennas 208, and an amplifier unit 210, similar to those described above. The external antennas 206, internal antennas 208, and amplifier unit 210, however, are configured for a modular architecture.

A modular architecture provides flexibility in the number and types of wireless frequency bands supported by the modular wireless repeater 600. Use of certain frequency bands may change over time. New technology or market pressures may make certain frequency bands obsolete or require additional frequencies or frequency bands. Non-modular wireless repeaters are unable to adapt to these changing conditions. Consequently, the non-modular wireless repeater may have to be periodically completely replaced. The modular wireless repeater 600 avoids this problem by allowing grouping of components common to a specific frequency band into readily replaceable modules.

The modular wireless repeater 600 allows for external antennas 206 and internal antennas 208 to be modularly connected to an amplifier unit 210. Of course, the modular connection between the antennas 206, 208 and the amplifier unit 210 may be implemented in a variety of ways.

In one embodiment, the modular wireless repeater 600 includes an external antenna set 602 and an internal antenna set 604. The external antenna set 602 includes the external antennas 206 and a connection strip 606. As mentioned above, the external antennas 206 are positioned outside 202 and preferably in an area suitable for detecting wireless signals over a broad range such as from about 800 MHz to about 5800 MHz.

Preferably, the connection strip 606 is readily accessible with respect to the external antennas 206. The connection strip 606 may be outside 202 or inside 204. In one embodiment, the connection strip 606 may be inside 204 and accessible to the external antennas 206 by way of a conduit through the building 108.

A connection strip 606 provides a modular connection between the external antennas 206 and the remaining components of the modular repeater 600. In one embodiment, the connection strip 606 comprises a plurality of connections 608. Preferably, the connections 608 are conventional coaxial connections, though those of skill in the art will recognize that a variety of different types of connections may be used.

In one embodiment, each external antenna 212 is connected to a connection 608. Occupied connections 608 are indicated in FIG. 6 by the shaded circles. Available connections 608 are indicated by the blank circles. Preferably, the connection strip 606 includes at least one available connection 608. The available connection 608 allows for future expansion to accommodate a different frequency band.

Preferably, the modular wireless repeater 600 includes an internal connection strip 606 that is positioned inside 204 between the amplifier unit 210 and the internal antennas 208. As described in relation to the external connection strip 606, the internal connection strip 606 includes connections 608 that are connectable to internal antennas 214.

Referring still to FIG. 6, in one embodiment, the amplifier unit 210 is connected by way of the connection strips 606 with the external antennas 206 and the internal antennas 208. The amplifier unit 210 is configured to receive one or more modular amplifiers 610. In one embodiment, the amplifier unit 210 may include one or more slots 612 for receiving circuit cards comprising a modular amplifier 610. Preferably, the amplifier unit 210 includes at least one available slot 612.

A modular amplifier 610 amplifies signals from an external antenna 212 and a corresponding internal antenna 214 in a specific frequency band. Preferably, the modular amplifier 610 includes a bandpass filter 404 and gain component 406 for the specific frequency band. Thus, the modular amplifier 610 preferably includes amplification circuitry specific to a particular frequency band on a single printed circuit board. In one embodiment, the modular amplifier 610 amplifies incoming wireless signals for a single specific frequency band. Alternately, the modular amplifier 610 may amplify multiple frequency bands.

Together, the external antenna 212, internal antenna 214, and modular amplifier 610 cooperate to provide a modular repeater for wireless signals within a specific wireless frequency band. Adapting the modular wireless repeater 600 for different or additional wireless frequency bands is straight-forward.

Hereinafter, frequency bands will be identified, for clarity, by a common name, a primary wireless device, or protocol that utilizes the frequency band. This identification is not intended to limit the scope of the present invention which is defined by the claims. Accordingly, references to the “GSM-900” (Global System for Mobile Communication—900 MHz) wireless signal band refer to wireless frequencies for cell phones from about 880 MHz to 960 MHz. References to a PCS-1800 wireless signal band refer to wireless frequencies from about 1850 MHz to 1990 MHz. References to GPS wireless signal frequencies refer to wireless frequencies from of approximately 1575.42 MHz, 1176.45 MHz (anticipated), or 1227.60 MHz (anticipated). Actual frequency bands and frequencies may change over time or vary from location to location. Other frequency bands may also be added over time.

For example, suppose the modular wireless repeater 600 supports wireless signals within three specific wireless frequency bands such as Global System for Mobile Communication (GSM-900) band, Personal Communications System (PCS-1800) band, and Global Positioning System (GPS) frequencies. Accordingly, the modular wireless repeater 600 includes three external antennas 212, one configured to detect and send GSM-900 band frequencies, PCS-1800 band frequencies, and GPS frequencies, respectively. As mentioned above, support for three distinct frequency bands does not require that three separate external antennas 212 and three separate internal antennas 214 be used. Certain antennas 212, 214 may service multiple frequency bands.

The external antennas 212 are connected to the occupied connections 608 (shaded). Similarly, the modular wireless repeater 600 may include up to three internal antennas 214, one configured to detect and send GSM band frequencies, PCS band frequencies, and GPS frequencies, respectively. The internal antennas 214 are connected to the occupied connections 608 (shaded).

The amplifier unit 210 may include three cards that are positioned in slots 612. Each card is configured to provide a modular amplifier 610 specific to the GSM-900 band frequencies, PCS-1800 band frequencies, and GPS frequencies. Furthermore, the amplifier unit 210 includes a controller 402 (See FIG. 4) configured to route wireless signals to the appropriate modular amplifier 610 card.

If a new wireless communication band became available, the modular wireless repeater 600 may be readily adapted to support the new frequency band. Suppose the new frequency band is GSM-1800 referring to frequencies between about 1710 MHz and about 1880 MHz. To add support for the new frequency, an external antenna 212 and an internal antenna 214 configured to operate within the GSM-1800 frequency band may be installed in the external modular antenna set 602 and the internal modular antenna set 604, respectively. Alternatively, if an external antenna 212 and an internal antenna 214 already support the GSM-1800 frequency band, no additional antennas 212, 214 need to be added to the external modular antenna set 602 or the internal modular antenna set 604.

If an external antenna 212 is added, the external antenna 212 is connected to a free connection 608 (represented by a blank circle) of the external connection strip 606. If an internal antenna 214 is added, the internal antenna 214 is connected to a free connection 608 (represented by a blank circle) of the internal connection strip 606.

Next, a modular amplifier card 610 configured to amplify wireless signals in the GSM-1800 frequency band is inserted into an open slot 612 of the amplifier unit 210. Finally, in a preferred embodiment, new software may be installed on the controller 402 (See FIG. 4) that is configured to support the new GSM-1800 frequency band. Alternatively, the controller 402 may already be configured to support new frequency bands such as GSM-1800.

Referring generally to FIG. 2, in an alternative embodiment, the present invention may serve as a wireless repeater for an internal wireless Local Area Network (LAN). In one embodiment, substantially the same components described above in relation to FIGS. 1-4 are used in this embodiment.

In this alternative embodiment, rather than external antennas 206 and internal antennas 208, the wireless repeater includes a plurality of first antennas (not shown) and a plurality of second antennas (not shown). The first antennas and second antennas are located at different places within the building 108. For example, the communication connection 216 may run through one or more walls within the building to a central computer network room (not shown) that comprises one or more servers (not shown) that provide LAN network services such as storage, messaging, printing, and the like. The first antennas or second antennas may be positioned in a relatively large open area such as above an exhibit hall floor or warehouse retail store.

Furthermore, the present invention may include antennas 212, 214 and a modular amplifier to support wireless LAN communication with wireless devices 106. For example, the system may support Institute of Electrical and Electronics Engineers (IEEE) 802.11 frequency band referring to frequencies between about 2400 MHz and about 2483.5 MHz. As described above, this alternative embodiment allows for wireless signals to be readily passed between wireless devices 106 in the area of the first antennas or a wireless receiver (not shown) located for example in a server room.

Those of skill in the art recognize the numerous applications for such an alternative embodiment. In a retail context, users may register their wireless devices 106 with a retailer such that once a user enters a retail store, store information, marketing information, or the like may be provided to the user's wireless device 106 either on demand or automatically.

The present invention is simple, inexpensive and supports a plurality of wireless frequency bands. The present invention does not transform the wireless signal, which minimizes the complexity and the number of hardware components. The present invention amplifies the wireless signals from outside and inside a building without adding sufficient power to the signal that regulatory licensing is required. In addition, the wireless repeater accommodates different wireless signal bands through a modular architecture.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A wireless repeater comprising:
a plurality of external antennas, each external antenna configured to operate within one or more wireless frequency bands;
a plurality of internal antennas, each internal antenna configured to operate within the one or more wireless frequency bands associated with the external antennas; and
an amplifier unit in electrical communication with the external antennas and the internal antennas, the amplifier unit configured to identify a frequency associated with an incoming wireless signal from a plurality of wireless frequency bands, determine a signal strength for the incoming wireless signal, and adjust the signal strength of the incoming wireless signal to compensate for a loss in signal strength between the external antennas and the internal antennas without substantially transforming the signal.

2. The wireless repeater of claim 1, wherein the amplifier unit comprises a diplexer module configured to direct the incoming wireless signal according to uplink frequencies and downlink frequencies.

3. The wireless repeater of claim 1, wherein the amplifier unit comprises a bandpass filter module configured to pass the incoming wireless signal based on the frequency of the incoming wireless signal.

4. The wireless repeater of claim 3, wherein the bandpass filter module comprises a plurality of bandpass filters each configured to pass a specific wireless frequency block.

5. The wireless repeater of claim 4, wherein the at least one bandpass filter is configured to filter between a first incoming wireless signal and a channel adjacent to a channel for a second incoming wireless signal according to the frequencies for the first incoming wireless signal and the second incoming wireless signal.

6. The wireless repeater of claim 1, wherein the amplifier unit comprises a gain module configured to amplify the incoming wireless signal to the determined signal strength for the incoming wireless signal.

7. The wireless repeater of claim 1, wherein the modular wireless repeater is configured to repeat wireless signals having frequencies between about 800 MHz to about 5800 MHz.

8. The wireless repeater of claim 1, wherein the wireless repeater is configured to repeat mobile telephone wireless frequencies.

9. The wireless repeater of claim 1, wherein the wireless repeater is configured to repeat Global Positioning Satellite (GPS) frequencies.

10. A system for repeating a wireless signal without transforming the wireless signal, the system comprising:
a controller configured to identify a frequency for an incoming wireless signal from a plurality of wireless frequency bands receivable by the controller and determine a signal strength for the incoming wireless signal;
a bandpass filter configured to pass the identified frequency associated with the incoming wireless signal; and
a gain component configured to adjust the signal strength of the incoming wireless signal to substantially restore the incoming signal to the signal strength determined by the controller for passage between an external antenna and an internal antenna in communication with the controller.

11. The system of claim 10, further comprising a diplexer module configured to direct the incoming wireless signal according to uplink frequencies and downlink frequencies.

12. The system of claim 10, wherein the bandpass filter is configured to filter the incoming wireless signal according to a plurality of allocated frequency blocks within a frequency band associated with the incoming wireless signal.

13. The system of claim 10, wherein the bandpass filter is configured to filter between a first incoming wireless signal for a channel adjacent to a channel for a second incoming wireless signal according to the frequencies for the first incoming wireless signal and the second incoming wireless signal.

14. The system of claim 10, wherein the system is configured to repeat Global Positioning Satellite (GPS) frequencies.

15. A method for repeating a wireless signal without transforming the wireless signal, the method comprising:
identifying a frequency associated with an incoming wireless signal from a plurality of predetermined wireless frequency bands;
determining a signal strength for the incoming wireless signal;
adjusting the signal strength of the incoming wireless signal to compensate for a loss in signal strength between a plurality of first antennas in communication with a plurality of second antennas carrying the incoming wireless signal without substantially transforming the signal; and
passing the incoming wireless signal having an adjusted signal strength between the first antennas and second antennas.

16. The method of claim 15, further comprising filtering the incoming wireless signal according to uplink frequencies and downlink frequencies.

17. The method of claim 15, further comprising directing the incoming wireless signal to a specific bandpass filter corresponding to the identified frequency.

18. The method of claim 15, further comprising filtering the incoming wireless signal based on the identified frequency.

19. The method of claim 15, further comprising filtering the incoming wireless signal according to a plurality of allocated frequency blocks within a frequency band associated with the incoming wireless signal.

20. The method of claim 15, further comprising filtering between a first incoming wireless signal for a channel adjacent to a channel for a second incoming wireless signal according to the frequencies for the first incoming wireless signal and the second incoming wireless signal.

21. The method of claim 15, wherein the incoming wireless signal has a frequency from about 800 MHz to about 5800 MHz.

22. An apparatus for repeating a wireless signal without transforming the wireless signal, the apparatus comprising:
means for identifying a frequency associated with an incoming wireless signal from a plurality of predetermined wireless frequency bands;
means for determining a signal strength for the incoming wireless signal;
means for adjusting the signal strength of the incoming wireless signal to compensate for a loss in signal strength between a plurality of external antennas in communication with a plurality of internal antennas carrying the incoming wireless signal without substantially transforming the signal; and
means for passing the incoming wireless signal having an adjusted signal strength between the external antennas and internal antennas.

23. The apparatus of claim 22, further comprising means for filtering the incoming wireless signal according to uplink frequencies and downlink frequencies.

24. The apparatus of claim 22, further comprising means for filtering the incoming wireless signal based on the identified frequency.

25. An article of manufacture comprising a program storage medium readable by a processor and embodying one or more instructions executable by a processor to perform a method for repeating a wireless signal without transforming the wireless signal, the method comprising:
identifying a frequency associated with an incoming wireless signal from within a plurality of predetermined wireless frequency bands;
determining a signal strength for the incoming wireless signal;
adjusting the signal strength of the incoming wireless signal to compensate for a loss in signal strength between a plurality of external antennas in communication with a plurality of internal antennas carrying the incoming wireless signal without substantially transforming the signal; and
passing the incoming wireless signal having an adjusted signal strength between the external antennas and internal antennas.

26. The article of manufacture of claim 25, wherein the method further comprises filtering the incoming wireless signal according to uplink frequencies and downlink frequencies.

27. The article of manufacture of claim 25, wherein the method further comprises filtering the incoming wireless signal based on the identified frequency.

28. The article of manufacture of claim 25, wherein the method further comprises filtering the incoming wireless signal according to a plurality of allocated frequency blocks within a frequency band associated with the incoming wireless signal.

29. The article of manufacture of claim 25, wherein the incoming wireless signal has a frequency between about 800 MHz to about 5800 MHz.

30. A modular wireless repeater comprising:
an external antenna set comprising a plurality of external antennas, each external antenna configured to operate within one or more specific wireless frequency bands, the external antenna set having at least one available connection;
an internal antenna set comprising a plurality of internal antennas, each internal antenna configured to operate within one or more specific wireless frequency bands corresponding to one of the external antennas, the internal antenna set having at least one available connection; and
an amplifier unit in electrical communication with the external antenna set and the internal antenna set, the amplifier unit configured to receive a plurality of modular amplifiers, each modular amplifier configured to cooperate with one or more external antennas, and one or more internal antennas to provide a modular repeater for wireless signals within a specific wireless frequency band.
